(19) United States
(12) Patent Application Publication
(10) Pub. No.: US 2021/0078342 A1
(43) Pub. Date: Mar. 18, 2021

(54) SETTING PRINTER PARAMETERS

(71) Applicant: Hawlett-Packard Development Company, L.P., Spring, TX (US)

(72) Inventor: Alan Jacques, Corvallis, OR (US)

(73) Assignee: Hawlett-Packard Development Company, L.P., Spring, TX (US)

(21) Appl. No.: 17/048,147

(22) PCT Filed: Apr. 26, 2018
(86) PCT No.: PCT/US2018/029510

§ 371 Date: Oct. 16, 2020

(51) Int. Cl. B41J 11/00; B41J 2/21

(52) U.S. Cl. CPC B41J 11/009; B41J 2/21

(57) ABSTRACT

The present disclosure is drawn to setting printer parameters. In one example, a method of setting printer parameters can include loading a print medium into a printer. The print medium can include a print surface and an identification code on the print surface, the identification code including multiple surface property discontinuities on the print surface, wherein the print surface is continuous at the multiple surface property discontinuities, and wherein the multiple surface property discontinuities are non-additive and are grouped together at a location on the print surface. The surface property discontinuities can be detected using a sensor integrated with the printer to read the identification code. An operating parameter of the printer can be selected based on the identification code.

### BACKGROUND

Digital printing methods, including ink jet printing and laser printing, have become a popular way of recording images on various media surfaces. Some of these reasons include low printer noise, variable content recording, capability of high speed recording, and multi-color recording. Additionally, these advantages can be obtained at a relatively low price to consumers. Consumer demand has led to the development of a wide variety of different print media for specialized applications. For example, available types of print media range from plain office paper, to paper having specialized ink receiving coatings, to glossy paper for posters and magazines, to transparency sheets, to fabrics, and many others.

### BRIEF DESCRIPTION OF THE DRAWINGS

Additional features of the disclosure will be set forth in the detailed description which follows, taken in conjunction with the accompanying drawings, which together illustrate, by way of example, features of the present technology.

FIG. 1 is a flowchart of an example method of setting printer parameters in accordance with an example of the present disclosure;

FIG. 2 is a top down view of an example print medium usable with the systems and methods of setting printer parameters in accordance with an example of the present disclosure;

FIG. 3 is a cross-sectional view of an example print medium with a light source and a sensor in accordance with an example of the present disclosure;

FIG. 4 is a cross-sectional view of an example print medium with a mechanical contact sensor in accordance with an example of the present disclosure;

FIG. 5 is a schematic view of an example system of setting printer parameters in accordance with an example of the present disclosure; and

FIG. 6 is a schematic view of another example system of setting printer parameters in accordance with an example of the present disclosure.

Reference will now be made to several examples that are illustrated herein, and specific language will be used herein to describe the same. It will nevertheless be understood that no limitation of the scope of the disclosure is thereby intended.

### DETAILED DESCRIPTION

The present disclosure is drawn to methods and systems for setting printer parameters, and in further examples, those printer parameters can be used for printing on a print medium used to assist with setting those printer parameters. For example, a method of setting printer parameters can include identifying a print surface by reading an identification code made up of discontinuities in a surface property of the print surface. In some examples, the method can also include loading a print medium into a printer. The print medium can include a print surface and an identification code on the print surface. The identification code can include multiple surface property discontinuities on the print surface, where the print surface is continuous at the multiple surface property discontinuities. The multiple surface property discontinuities can be non-additive and are grouped together at a location on the print surface. The surface property discontinuities can be detected using a sensor integrated with the printer to read the identification code. An operating parameter of the printer can be selected based on the identification code.

In certain examples, the discontinuous surface property of the print surface can be gloss, reflectance, roughness, coefficient of friction, adhesion, hardness, stiffness, or a combination thereof. In further examples, the sensor can include an optical sensor and detecting the multiple surface property discontinuities can include directing light toward the print surface and measuring the light reflected from the print surface, including from the multiple surface property discontinuities, using the optical sensor. In still further examples, the sensor can be a mechanical contact sensor and detecting the multiple surface property discontinuities can include contacting the print surface, including the multiple surface property discontinuities, with the mechanical contact sensor.

In other examples, the multiple surface property discontinuities can include individual surface property discontinuities that have a surface area from 500 μm² to 50,000,000 μm². In still other examples, the identification code can be constrained to within 1 cm of an edge of the print medium.

The operating parameter of the printer can include, in some examples, a blending ratio of multiple ink colors, a volume of ink printed per area of print medium, a printing speed, or a combination thereof. In some examples, the print surface can be printed onto using the printer with the selected operating parameter.

The present disclosure also extends to systems for setting printer parameters. In some examples, a system can include a print medium and a printer. The print medium can include a print surface and an identification code on the print surface. The identification can include multiple surface property discontinuities on the print surface. The print surface can be continuous at the multiple surface property discontinuities. The multiple surface property discontinuities can be non-additive and are grouped together at a location on the print surface. The printer can include a light source directable or directed towards the print medium when loaded in the printer. The printer can also include an optical sensor directable or directed towards the print medium to optically detect reflected discontinuities in the surface property at the identification code. An electro-optical converter can convert optical information related to the reflected discontinuities into electrical signal. A controller can receive the electric signal and set an operating parameter of the printer based on the electrical signal. In certain examples, the discontinuous surface property can include gloss, reflectance, roughness, or a combination thereof. In further examples, the light source can be directable or directed at an angle of incidence with respect to the print medium, and the optical sensor can be spaced apart from the light source.

In further examples, a system for setting printer parameters can include a print medium and a printer. The print medium can include a print surface and an identification code on the print surface. The identification can include multiple surface property discontinuities on the print surface. The print surface can be continuous at the multiple surface property discontinuities. The multiple surface property discontinuities can be non-additive and are grouped together at a location on the print surface. The printer can include a mechanical contact sensor to contact the print medium when loaded in the printer and to mechanically detect discontinuities in the surface property at the identification code. The printer can also include an electro-mechanical converter to convert mechanical information related to the discontinuities into electrical signal. A controller can receive the electrical signal and to set an operating parameter of the printer based on the electrical signal. In some examples, the discontinuous surface property can include roughness, coefficient of friction, adhesion, hardness, stiffness, or a combination thereof. In other examples, the mechanical contact sensor can be moveable with respect to the print medium. In still further examples, the mechanical contact sensor can include a stylus draggable along the print surface and a drag force sensor to detect the discontinuities by measuring changes in drag force on the stylus.

Rapid growth in mobile printing can produce an increased number of remote print job submissions. For example, users commonly print from smartphones or other mobile devices when the users are not at the location of their printer. In some cases, a user may be unaware of the type of print media that is loaded in the printer. Without a way to check the type of media loaded in the printer, the user may face problems such as printing on the wrong type of paper. Even if the user is in the same location as the printer, the user may not be able to easily identify the type of media by visual inspection because many types of media, such as different types of paper, look similar to the human eye. This may result in a mismatch between the type of media in the printer and the intention of the user. For example, a user may unexpectedly print a less important document, such as a recipe or email, on expensive photo paper. On the other hand, a user may wish to print a high quality photograph and accidentally print on lower quality office paper.

Additionally, various types of media can have differing useful or desirable printing parameters. For example, media that is more absorbent may be printed at higher speeds with less drying time because ink absorbs into the media more quickly, while less absorbent media may be printed at a lower print speed. Certain types of media may benefit from other printing parameters, such as volume of ink printed per unit area, or the mixing of multiple colors of ink to produce a certain visible color on the media (i.e., different color maps for different media types). Generally, it can be difficult to optimize printers for all the various types of media because a printer may be programmed to print with a small number of printing profiles, whereas media types may have a larger variety of different printing parameters. On the other hand, if printer drivers are designed to allow the user to select individual print profiles for every different type of print media, the user may be overwhelmed with the dozens or hundreds of different possible print profiles.

The present disclosure involves methods and systems for setting printer parameters using print media that include identification codes. These identification codes can be read and decoded by a printer to allow the printer to automatically select printing parameters for printing on the particular media type. Additionally, the identification codes can be relatively inconspicuous so that the appearance of the print media is not negatively affected. This is because the identification codes are not formed by a visible marking method, such as printing an ink barcode. Instead, the identification codes are made up of multiple discontinuities in a surface property of the print medium itself. In some cases, the identification codes may be unnoticeable by the human eye under normal lighting conditions.

As used herein, “surface property discontinuity” refers to an area of a print surface of a print medium that has been altered in some way to change a surface property of that area, so that the particular surface property is discontinuous at the transition from the bulk of the print surface to the area where the property has been altered. As an example, roughness is one surface property that may be made discontinuous. For example, a small area of the print surface may be roughened in order to form a discontinuity in the roughness of the surface. The small area would then have a higher roughness than the surrounding print surface. Alternatively, a small area can be made smoother than the surrounding print surface. Other properties can be made discontinuous, such as gloss or coefficient of friction. Multiple surface property discontinuities can be are grouped together and arranged in a way that encodes data about the print medium. For example, the surface property discontinuities may be in the form of bars that make up a barcode. However, such a barcode would be invisible or not readily noticeable to the human eye because the bar is not made by printing visible marks on the print medium. Instead, such a barcode would be made up of surface property discontinuities that do not change the color of the print surface.

The identification codes can allow printers to automatically select operating parameters that are useful for the particular print media loaded in the printer. The media type may also be displayed to the user so that the user is aware of the type of media before initiating a print job. Information about the type of print media used may also be collected electronically and used to provide valuable information about end-user demographics of various media types and usage rates of different media types across different regions or demographics.

The identification codes described herein can also provide greater flexibility compared to some other print media identification methods, such as printed bar codes. When printed codes are used to identify print media, the codes are often printed on a back side of the media so that the appearance of the front side is not degraded. Thus, printing may be performed on the front side of the media but not on the back side. Such printed codes may be read by specialized sensors that are not otherwise found in printers. Other methods may attempt to identify print media type from the physical properties of the entire print media surface, such as gloss, whiteness, brightness, and so on. These methods can also use specialized sensors, and it may be very difficult to detect minute differences in these properties in similar media types. In contrast, the identification codes described herein can allow for printing on both sides of the media, and in some cases the identification codes can be read by optical sensors that are already included in many printers. In other examples, the identification codes may be read by mechanical sensors that detect the surface property discontinuities mechanically.

In some examples, the sensor used to read to the identification codes can be a light reflectance sensor already included in many printers. Some printers include such a sensor to sense paper at or near edges and/or to measure the location of printed dots or lines on alignment test prints. The sensor may include a light emitting diode and a photo transistor receiver. These sensors may not be sufficient to identify a particular type of print media based on the surface reflectance of the medium alone. However, such a sensor can be used to detect changes in certain surface properties, such as gloss, reflectance, or roughness. Thus, some types of identification codes described herein can be read by these sensors in order to identify the particular media type.

In further examples, the sensor can be a mechanical contact sensor. Such a sensor can detect discontinuities in certain surface properties by contacting the print surface of the print media. For example, one type of mechanical contact sensor can include a stylus that is dragged along the print surface. The drag force on the stylus can be measures, and an increase in drag force can correspond to a rougher surface, while a decrease in drag force can correspond to a smoother surface. Other surface properties can also be measured mechanically, such as coefficient of friction, adhesion, hardness, stiffness, and others.

In some cases, the identification codes can be made up of a plurality of locations that either have an altered surface property or the normal surface property of the remainder of the print surface. The locations that have an altered surface property, also called surface property discontinuities, can be arranged with areas that have the normal, unaltered surface property to form a code. As one example, this can encode binary data, with the surface property discontinuities representing a “1” value and the areas with unaltered surface property representing a “0” value. Using such codes, individual unique types of print media can be labelled with an identification code that can be read by a printer having the appropriate sensor.

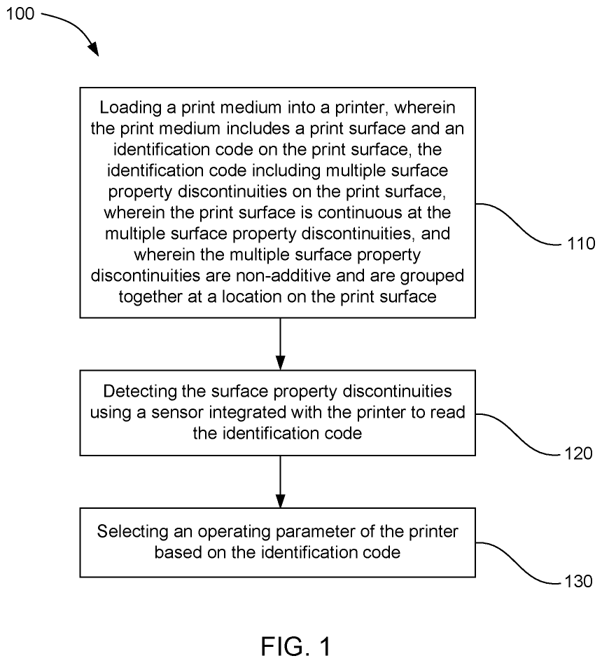

With this background in mind, FIG. 1 is a flowchart of an example method 100 of setting printer parameters in accordance with the present disclosure. The method includes: loading a print medium into a printer, wherein the print medium includes a print surface and an identification code on the print surface, the identification code including multiple surface property discontinuities on the print surface, wherein the print surface is continuous at the multiple surface property discontinuities, and wherein the multiple surface property discontinuities are non-additive and are grouped together at a location on the print surface 110; detecting the surface property discontinuities using a sensor integrated with the printer to read the identification code 120; and selecting an operating parameter of the printer based on the identification code 130.

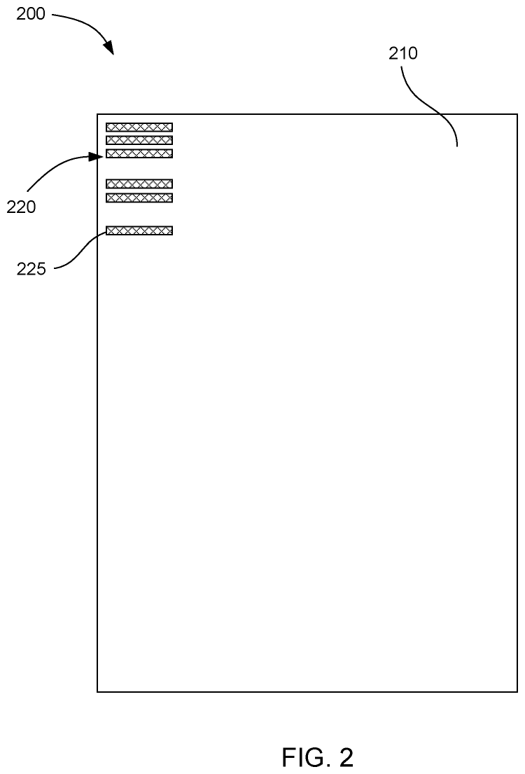

To more clearly illustrate the identification codes made up of surface property discontinuities, FIG. 2 shows a top view of an example print medium 200 in the form of a sheet having a print surface 210. An identification code 220 is on the print surface. The identification code includes multiple surface property discontinuities 225 on the print surface. The surface discontinuities are areas on the print surface that have a surface property that is different from the remainder of the print surface. The surface property discontinuities are non-additive, meaning that the altered surface property is not altered by adding additional material to the surface. The print surface itself is continuous throughout the area of the surface property discontinuities, meaning that there are no holes, perforations, notches, etc. in the print surface in this area. Therefore, the surface itself is not discontinuous, but a property of the surface is discontinuous. The surface property discontinuities are grouped together at a location on the print surface, forming the identification code.

A variety of surface properties can be made discontinuous in order to form the multiple surface property discontinuities making up the identification code. Non-limiting examples of surface properties can include gloss, reflectance, roughness, coefficient of friction, adhesion, hardness, stiffness, and others. The various surface properties may be made is discontinuous by any suitable action on the print surface.

In certain examples, the surface property that is discontinuous can be gloss. In some examples, the gloss discontinuities forming the identification code can have a higher gloss compared to the remainder of the print surface. In alternative examples, the gloss discontinuities can have a lower gloss. In some examples, the gloss of the print surface can be increased by smoothing the print surface, pressing the surface, polishing the surface, sanding the surface, or by any other suitable method. In certain examples, a print medium may include ingredients that can become glossier upon application of heat, such as polymers that can form a glossy film upon application of sufficient heat. In such examples, the gloss of the surface can be increased by applying heat to multiple areas to form gloss discontinuities. In further examples, the gloss of the print surface can be reduced by roughening the surface, sanding the surface, buffing the surface, pressing a less glossy pattern into the surface, scuffing the surface, and other suitable methods.

In other examples, the surface property that is discontinuous can be reflectance. In some examples, the reflectance of the print surface can be increased by smoothing the surface, pressing the surface, polishing the surface, sanding the surface, or by any other suitable method. In other examples, the reflectance of the print surface can be reduced by roughening the surface, sanding the surface, buffing the surface, pressing a less reflective pattern into the surface, scuffing the surface, and other suitable methods.

In further examples, the surface property that is discontinuous can be roughness. The roughness of the surface can be increased by sanding the surface with a rough sanding medium, pressing a rough pattern into the surface, cutting small slits into the surface, and other suitable methods. The roughness of the surface can be reduced by sanding with a smoother sanding medium, pressing the surface, polishing the surface, and other suitable methods. In some examples, the print medium can include an ingredient that becomes less rough upon application of heat, such as a polymer that forms a smooth film when heated. In such examples, the roughness can be decreased by applying sufficient heat to the print surface.

In still further examples, the surface property that is discontinuous can be coefficient of friction. The coefficient of friction can be increased by roughening the surface, sanding the surface, buffing the surface, pressing a high friction pattern into the surface, and so on. The coefficient of friction can be reduced by smoothing the surface, pressing the surface, polishing the surface, and other methods. In some examples, the print medium can include an ingredient that either increases or decreases the coefficient of friction when heated. Thus, the coefficient of friction can be changed by applying heat in some examples.

In further examples, the properties of adhesion, hardness, and stiffness may be altered by similar methods, such as by roughening, smoothing, pressing, sanding, or heating the surface. In some examples, the print medium can include an ingredient that changes with respect to adhesion, hardness, or stiffness when heat is applied. For example, the print medium may include a polymer that can form a tacky film to increase adhesion, or hard or stiff film to increase hardness or stiffness. In further examples, hardness or stiffness can be increased by compressing the print medium.

In further examples, the surface property that is discontinuous can include audio reflectance properties at the surface. A smooth surface or a surface with local concave grooves can reflect and amplify soundwaves directed toward the surface differently compared to a convex surface that may disperse and diminish the reflected soundwaves. Smooth surface portions and rough surface portions can also reflect sound differently. Thus, any combination of surface differences can be detectable using sound, in some instances. For example, an audio emitter can direct high frequency soundwaves, above the range of human hearing, toward the surface. An audio receiver can include sensor to measure the reflected soundwaves to detect discontinuities in the audio reflectance of the surface.

In certain examples, the surface property discontinuities can be sufficiently small in size to be not readily noticeable by the human eye. For example, the surface property discontinuities may be small enough that they are invisible to the human eye. In other examples, the surface property discontinuities can be visible upon close inspection, but not noticeable under normal usage. In some particular examples, the surface property discontinuities can have a surface area from 500 μm² to 50,000,000 μm². In further examples, the surface property discontinuities can be shaped as bars or strips, having a width from 5 μm to 200 μm and a length from 50 μm to 10,000 μm.

In further examples, the surface property discontinuities can be spaced a distance apart from adjacent surface property discontinuities. In certain examples, the surface property discontinuities can be spaced at from 5 μm to 1,000 μm relative to adjacent surface property discontinuities. In further examples, the surface property discontinuities can be spaced at from 50 μm to 500 μm relative to adjacent surface property discontinuities.

In certain examples, the identification code can be placed in a location on the print surface that is relatively inconspicuous, such as at or near an edge or corner of the print surface. In some examples, the identification code can be within 1 cm of an edge of the print surface. In other examples, the identification code can be within 3 mm or within 1 mm of an edge of the print surface. In further examples, the identification code can be located in a margin of the print medium. In some cases a printer may be programmed not to print in the margin.

The identification codes can encode information about the print medium. In certain examples, the identification code can identify the type of print medium. In other examples, the identification code can encode information about properties of the print medium, such as color, absorptivity, gloss level, and so on.

In still further examples, the identification code can encode specific operating parameters to be used by a printer when printing on the print medium.

In some examples, the identification code can encode information as a binary code by including multiple surface locations that can contain either a surface property discontinuity or an unaltered property area. Surface property discontinuities can occupy a plurality of the surface locations, and a second plurality of surface locations can remain as unaltered property areas. The surface property discontinuities and unaltered property areas can represent a binary code. For example, a surface property discontinuity can represent a “1” in the code, and an unaltered property area can represent a “0” in the code. An identification code of this type can encode dozens or hundreds of individual types of print media with 6 or 7 surface locations. In some examples, the multiple surface locations can be equally spaced at a distance from 20 μm to 1,000 μm.

In certain examples, the surface property discontinuities can be detected using an optical sensor. In some such examples, the surface property discontinuities can be detected by directing a light source toward the print surface and measuring the light reflected from the print surface, including from the multiple surface property discontinuities, using the optical sensor.

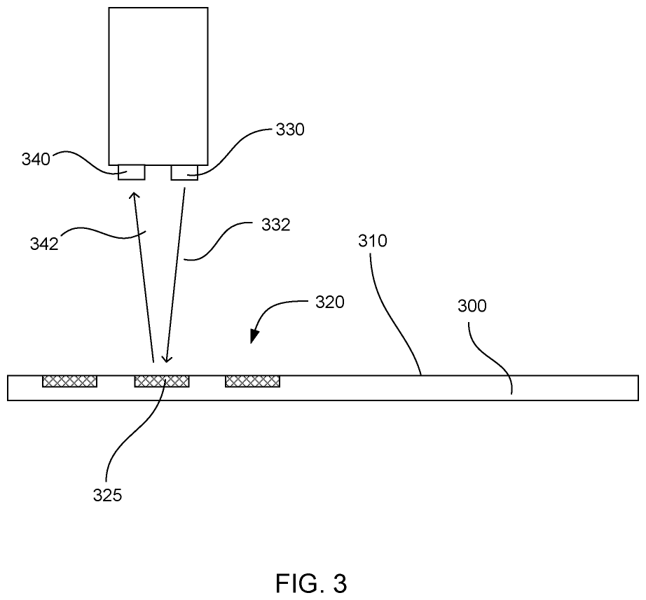

To illustrate detecting surface property discontinuities using an optical sensor, FIG. 3 shows a cross-sectional view of a print medium 300 with a light source 330 and optical sensor 340 to read the identification code 320 on the print surface 310 of the print medium. In this example, the surface property discontinuities 325 that make up the identification code are shown as shaded rectangles on the print surface. Although the surface property discontinuities are shown visually as shaded rectangles in the figure, in reality the surface property discontinuities would not have a different color than the remainder of the print surface. Additionally, it is noted that the surface property discontinuities in the figure are not drawn to scale. Typically the surface property discontinuities can be small in size in order to be invisible or not readily noticeable to the human eye. In this example, the optical sensor can read the microembossed identification code by measuring the intensity of light reflected back from the print surface. The light source can shine light, represented by arrow 332, toward the print surface at an incident angle. Reflected light, represented by arrow 342, can be measured by the optical sensor.

In one example, the surface property discontinuities can have a higher reflectance compared to the remainder of the print surface. In this example, the optical sensor would detect an increase in reflected light intensity when the light from the light source reflects off one of the surface property discontinuities, and a decrease in light intensity when the light from the light source reflects off an area that has an unaltered reflectance. In some examples, the light source and/or the optical sensor can be moveable with respect to the print medium. Thus, the optical sensor can be used to read the identification code by measuring light reflecting off the surface property discontinuities and unaltered property areas as the sensor and/or light source moves over the print surface.

It is noted that the specific amount of light reflected by the print surface can be different depending on the type of print media. Additionally, the change in light intensity detected by the sensor can vary depending on the type of print media and particular property that is discontinuous in the surface property discontinuities. For example, more glossy media can exhibit a more pronounced increase and decrease in reflected light intensity when the sensor and/or light source move over the identification code. Gloss generally refers to the property of reflecting more light at the same incident angle at which the light strikes the print surface. In some examples, changes in gloss can be detected by positioning the optical sensor and the light source in such a way that light reflected at the incident angle is directed toward the optical sensor. Glossier surfaces can then reflect more light to the optical sensor, while less glossy surfaces would reflect less light toward the optical sensor.

Additionally, the sensor can often measure small variations in reflected light intensity even when the sensor and/or light source moves over blank, unaltered media. This “noise” can tend to be greater for media with rough or less-uniform surfaces. However, the size of the surface property discontinuities and the magnitude of change in the particular surface property can be designed so that the measured light intensity can have a sufficient signal to noise ratio to allow for accurate reading of the identification codes.

In further examples, the surface property discontinuities can be detected using a mechanical contact sensor. Several non-limiting examples of surface properties that can be detected using a mechanical contact sensor can include roughness, coefficient of friction, adhesion, hardness, stiffness, and others. Some properties may be detectable by either a mechanical sensor or an optical sensor, such as roughness. However, other properties can be more difficult to detect optically and are more amenable to mechanical detection, such as coefficient of friction, adhesion, hardness, and stiffness.

In various examples, the mechanical contact sensor can be a member that contacts the print surface. Non-limiting examples of mechanical contact sensors can include a stylus, a wire, a wheel, a brush, or any other member that can detect surface property discontinuities by contacting the print surface. In a particular example, the mechanical contact sensor can include a stylus that is draggable along the print surface. This can be used to detect changes in roughness, coefficient of friction, or adhesion. A drag force sensor can be associated with the stylus to sense the force exerted on the stylus by the print surface as the stylus is dragged along the print surface. An area with a higher roughness, coefficient of friction, or adhesion can increase the amount of drag force. Thus, the drag force sensor can detect discontinuities in these properties.

In further examples, the mechanical contact sensor can press against the print surface to measure stiffness or hardness. As used herein, “stiffness” refers to the property of resisting bending of the print medium. As used herein, “hardness” refers to the property of the print surface resisting being scratched or punctured. Accordingly, mechanical contact sensors can be designed to detect discontinuities in these properties. For example, a stylus may be pressed against the print medium with a known or consistent force in multiple locations on the print surface to detect areas that have lower or higher stiffness. In another example, a sharp pointed stylus can be pressed into the print surface to measure hardness of the print surface.

In yet another example, a stylus may be repeatedly pressed and retracted from the surface to measure the force expended to retract the stylus off the surface, to measure the adhesion of the surface.

In other examples, a wheel can contact the print surface to detect changes in roughness, coefficient of friction, or adhesion. A force sensor may be used to measure the amount of force exerted on the wheel by the print surface. In various examples, the wheel may be stationary or spinning. In some examples, the wheel can be spun at a constant rate of speed and the force of the print surface on the wheel can be measured to determine the coefficient of friction of the print surface.

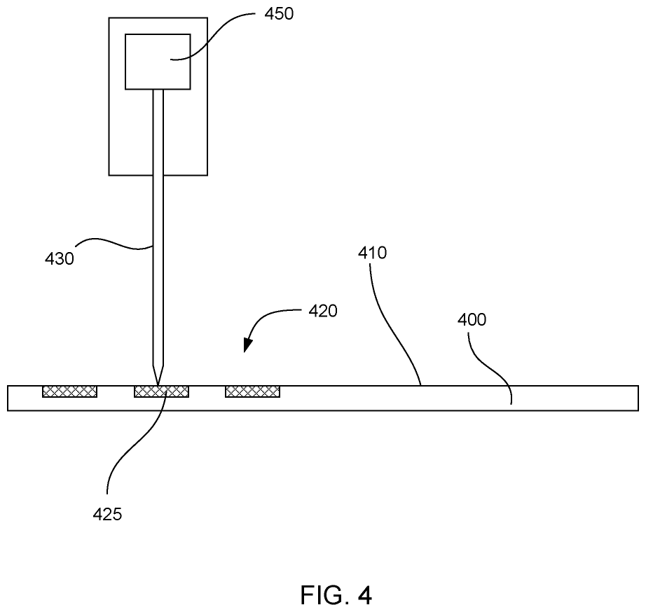

FIG. 4 shows another example print medium 400 with a mechanical sensor 430. The mechanical sensor is a stylus that can be dragged on the print surface 410 of the print medium. The stylus is associated with a drag force sensor 450 that can measure the force exerted on the stylus by the print surface. The surface property discontinuities 425 can be areas of higher coefficient of friction, for example. The drag sensor can measure an increase in drag force when the stylus is dragged over the surface property discontinuities, and a reduced drag force when the stylus is dragged over the remainder of the print surface. In this way, the drag sensor and stylus can read the identification code 420 on the print surface.

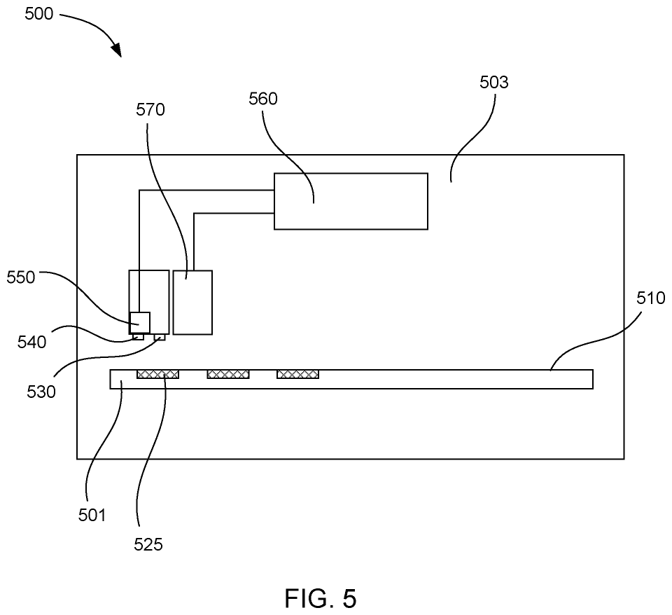

FIG. 5 shows a schematic of an example system 500 in accordance with an example of the present disclosure. The system includes a print medium 501 and a printer 503. The print medium can include a print surface 510 with surface property discontinuities 525 on the print surface making up an identification code. It should be noted that the surface property discontinuities are not drawn to scale in this figure. As explained above, the surface property discontinuities can be sufficiently small that they are not easily noticeable by the human eye. The printer can include a light source 530 directed towards the print surface. An optical sensor 540 is spaced apart from the light source. The optical sensor can optically detect reflected discontinuities from the print surface introduced by the identification code. An electro-optical converter 550 can convert the optical information related to the reflected discontinuities into electrical signal. The electro-optical converter can be connected to a controller 560. The controller can receive the electrical signal from the electro-optical converter. The controller can then set an operating parameter of the printer based on the electrical signal. The example shown in FIG. 5 also includes an inkjet printhead 570 that can be used by the printer to print on the print surface of the print medium.

In various examples, systems can allow the light source and/or the optical sensor to be moveable with respect to the print medium. In some examples, the light source and optical sensor can be fixed with respect to the printer, but the printer can move the print medium past the light source and sensor using a feeding mechanism such as rollers. In other examples, the light source and/or sensor can be moveable with respect to the printer, so that the light source and/or sensor can move over different areas of the print medium even when the print medium is stationary. In certain examples, the light source or the optical sensor, but not both, may be fixed with respect to the print medium. In some such examples, identification codes can be read by moving the light source while the optical sensor remains stationary, or by moving the optical sensor while the light source remains stationary. In either of these cases, the changing angle of incidence of the light reflecting off the surface property discontinuities can allow the optical sensor to detect the surface property discontinuities, in some examples. In still further examples, the light source and the optical sensor can move together with respect to the print medium. In certain examples, the light source and/or optical sensor can be mounted on a carriage together with a printhead so that the light source and/or optical sensor can move across the print surface in the same manner as the printhead.

In various examples, the identification codes can be read by the printer while the printer moves the print medium past the light source and optical sensor. In some such examples, the identification codes may be located at or near (along) a side edge of the print medium, so that the codes move past the light source and the optical sensor as the print medium moves in the printer. In other examples, the codes can be located at or near (along) a top or bottom edge of the print medium. In other examples, the light source and optical sensor can be mounted on a carriage with a printhead. The carriage can move the light source and sensor across the print medium from side to side. In some such examples, the identification code can again be located at or near (along) a side edge or a top or bottom edge of the print medium. The surface property discontinuities making up the identification codes can be oriented in a direction that allows the surface property discontinuities to be read by the optical sensor. In some examples, the surface property discontinuities can be oriented perpendicular to the direction in which the optical sensor and/or light source moves. This orientation can allow for the changing intensity of light reflected from the surface property discontinuities so that the optical sensor can read the identification code. In further examples, a print medium can include two identification codes oriented at a right angle with respect one to another, to accommodate for different printers that may move the optical sensor and light source in a different direction than other printers. In another example, surface property discontinuities can be oriented diagonally so that a signal can be produced no matter which direction the optical sensor and light source move over the identification code.

In certain examples, the light source can include a visible light emitting diode, an infrared light emitting diode, a laser, a fluorescent bulb, and incandescent bulb, or a combination thereof. Generally, any light source capable of shining light at the print medium surface can be used. In further examples, the optical sensor can include a phototransistor, a photodiode, a CMOS sensor, or a combination thereof. In some cases, the electro-optical converter can be an integral part of the optical sensor, such as a phototransistor that provides a voltage proportional to the intensity of light hitting the phototransistor.

The controller can be programmed to receive electrical signals from the electro-optical converter. The controller can decode the identification code using the electrical signals. In some examples, the identification code can encode the type of print medium. The controller can decode the code to identify the print medium. The controller can then select appropriate operating parameters for the particular print medium. In certain examples, the controller can be in communication with a local memory with a stored list of print medium types and operating parameters for the print medium types. The controller can then access the local memory to determine operating parameters for printing on the print medium. In other examples, the controller can contact a server or another computer to access a list of print medium types and operating parameters.

In further examples, the identification code can encode information about properties of the print medium. For example, the identification code can include information about the porosity, gloss level, and so on of the print medium. The controller can then determine operating parameters for printing on a print medium having those properties.

In still further examples, the identification code can encode the operating parameters suitable for printing on the specific print medium. In such examples, the controller can decode the identification code, and then simply use the operating parameters encoded in the identification code.

In some examples, the operating parameter that is selected can be a color map, which can involve mixing multiple colors of ink when printing to achieve a particular color appearance in the printed image. In other examples, the operating parameter can include ink volume printed in a unit area, such as in a square centimeter. Some types of media can produce a clearer image with less ink, while other types of media may produce a better image with more ink. In still further examples, the operating parameter can involve drying time, as different media types having different absorptivities may benefit from different drying times. In some examples, the print speed can be adjusted to control the drying time, with slower print speed affording more drying time.

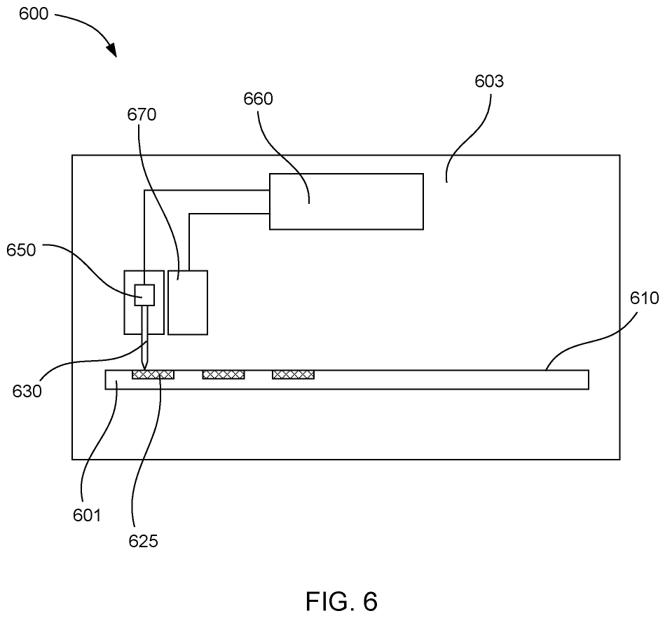

FIG. 6 shows a schematic of another example system 600 in accordance with an example of the present disclosure. The system includes a print medium 601 and a printer 603. This printer includes a mechanical contact sensor 630 that can contact the print surface 610 of the print medium. The mechanical contact sensor can be used to detect surface property discontinuities 625 in order to read the identification code 620. An electro-mechanical converter 650 can convert the mechanical information related to the discontinuities into electrical signal. The electro-optical converter can be connected to a controller 660. The controller can receive the electrical signal from the electro-optical converter. The controller can then set an operating parameter of the printer based on the electrical signal. The example shown in FIG. 6 also includes an inkjet printhead 670 that can be used by the printer to print on the print surface of the print medium.

In various examples, the mechanical contact sensor can include any of the mechanical contact sensor mentioned herein, such as a stylus, a wire, a wheel, a brush, and so on. The surface property discontinuities that can be detected with the mechanical contact sensor can include roughness, coefficient of friction, adhesion, hardness, stiffness, and others.

The electro-mechanical converter can be any component that can translate mechanical information detected by the mechanical contact sensor into an electric signal to send to the controller. In some examples, the electro-mechanical converter can be a separate component from the mechanical contact sensor. In other examples, the electro-mechanical converter can be integrated with the mechanical contact sensor. In one example, the mechanical contact sensor can be draggable stylus, and the electro-mechanical converter can be a drag force sensor. The drag force sensor can translate forces exerted on the stylus by the print surface into electrical signals.

Although the print medium has been referred to above primarily as being in the form of sheets, other types of print media can also be used. Many types of print media can be in the form of sheets, such as office paper, photo paper, transparencies, and so on. In some such examples, individual sheets can include an identification code so that printers can identify the media type. In other examples, the identification code can be applied to another part of the print medium, such as to a box or package that holds a number of sheets of the print medium. The identification code can be read by the printer when the print medium is loaded into the printer. In further examples, the print medium can be in the form of a roll or web. This can include a long, continuous length of the print medium that is fed through a printer. In such examples, the identification codes can be applied to the print medium roll. For example, an identification code may be applied at or near (along) an edge of the print medium so that the code can be read as the print medium is fed through the printer. The code can be repeated continuously at or near (along) the edge or at regular intervals. In other examples, the identification code can be applied to a core of the print medium roll, such as a cardboard tube around which the print medium has been rolled.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

As used herein, a plurality of items, structural elements, compositional elements, and/or materials may be presented in a common list for convenience. However, these lists should be construed as though individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if individual numerical values and sub-ranges are explicitly recited. For example, a weight ratio range of about 1 wt % to about 20 wt % should be interpreted to include the explicitly recited limits of 1 wt % and about 20 wt %, and also to include individual weights such as 2 wt %, 11 wt %, 14 wt %, and sub-ranges such as 10 wt % to 20 wt %, 5 wt % to 15 wt %, etc.

As a further note, in the present disclosure, it is noted that when discussing the print media, methods, and systems described herein, these discussions can be considered applicable to all of these examples, whether or not they are explicitly discussed in the context of that example. Thus, for example, in discussing details about the print media, such discussion also refers to the methods and systems, and vice versa.

### Examples

A print medium having an identification code is made by providing a sheet of HP Multipurpose office paper and pressing surface property discontinuities into the paper. The surface property discontinuities are smoother than the remainder of the paper surface. The multiple surface property discontinuities are grouped together at a location that is about 5 mm from the upper left corner of the media sheet. The surface property discontinuities form identification codes that encode the identity of the paper type.

The print medium is loaded into a printer having a mechanical stylus sensor. The mechanical stylus drags across the identification code as the print medium is loaded into the printer. A drag sensor detects the surface property discontinuities and sends an electric signal based on the surface property discontinuities to a controller integrated with the printer. The controller decodes the identification code by accessing a database of the identification codes. The controller selects the printing parameters for the particular paper type and then prints on the paper.

Because the smoother surface of the surface property discontinuities is more reflective than the rougher surface of the remainder of the print surface, the print medium in this example is also useable with a printer that uses an optical sensor to measure reflectance. The print medium can be loaded into such a printer and the printer can read the identification code using the optical sensor. The printer can then select printing parameters for the print medium based on the decoded identification code.

While the disclosure has been described with reference to certain examples, various modifications, changes, omissions, and substitutions can be made without departing from the spirit of the disclosure. It is intended, therefore, that the disclosure be limited by the scope of the following claims.

What is claimed is:

1. A method of setting printer parameters, comprising:
loading a print medium into a printer, wherein the print medium comprises a print surface and an identification code on the print surface, the identification code including multiple surface property discontinuities on the print surface, wherein the print surface is continuous at the multiple surface property discontinuities, and wherein the multiple surface property discontinuities are non-additive and are grouped together at a location on the print surface;
detecting the surface property discontinuities using a sensor integrated with the printer to read the identification code; and
setting an operating parameter of the printer based on the identification code.

2. The method of claim 1, wherein the discontinuous surface property of the print surface is gloss, reflectance, roughness, coefficient of friction, adhesion, hardness, stiffness, or a combination thereof.

3. The method of claim 1, wherein the sensor includes an optical sensor and detecting the multiple surface property discontinuities comprises directing light toward the print surface and measuring the light reflected from the print surface, including from the multiple surface property discontinuities, using the optical sensor.

4. The method of claim 1, wherein the sensor is a mechanical contact sensor and detecting the multiple surface property discontinuities comprises contacting the print surface, including at the multiple surface property discontinuities, with the mechanical contact sensor.

5. The method of claim 1, wherein the multiple surface property discontinuities include individual surface property discontinuities having a surface area from 500 μm² to 50,000,000 μm².

6. The method of claim 1, wherein the identification code is constrained to within 1 cm of an edge of the print medium.

7. The method of claim 1, wherein the operating parameter comprises a blending ratio of multiple ink colors, a volume of ink printed per area of print medium, a printing speed, or a combination thereof.

8. The method of claim 1, further comprising printing onto the print surface using the printer with the selected operating parameter.

9. A system for setting printer parameters, comprising:
a print medium, comprising:
a print surface, and
an identification code on the print surface, the identification code comprising multiple surface property discontinuities on the print surface, wherein the print surface is continuous at the multiple surface property discontinuities, and wherein the multiple surface property discontinuities are non-additive and are grouped together at a location on the print surface; and
a printer, comprising:
a light source directable or directed towards the print medium when loaded in the printer,
an optical sensor directable or directed towards the print medium to optically detect reflected discontinuities in the surface property at the identification code,
an electro-optical converter to convert optical information related to the reflected discontinuities into electrical signal, and
a controller to receive the electric signal and to set an operating parameter of the printer based on the electrical signal.

10. The system of claim 9, wherein the discontinuous surface property comprises gloss, reflectance, roughness, or a combination thereof.

11. The system of claim 9, wherein the light source is directable or directed at an angle of incidence with respect to the print medium, and wherein the optical sensor is spaced apart from the light source.

12. A system for setting printer parameters, comprising:
a print medium, comprising:
a print surface, and
an identification code on the print surface, the identification code comprising multiple surface property discontinuities on the print surface, wherein the print surface is continuous at the multiple surface property discontinuities, and wherein the multiple surface property discontinuities are non-additive and are grouped together at a location on the print surface;
a printer, comprising:
a mechanical contact sensor to contact the print medium when loaded in the printer and to mechanically detect discontinuities in the surface property at the identification code;
an electro-mechanical converter to convert mechanical information related to the discontinuities into electrical signal; and
a controller to receive the electrical signal and to set an operating parameter of the printer based on the electrical signal.

13. The system of claim 12, wherein the discontinuous surface property comprises roughness, coefficient of friction, adhesion, hardness, stiffness, or a combination thereof.

14. The system of claim 12, wherein the mechanical contact sensor is moveable with respect to the print medium.

15. The system of claim 12, wherein the mechanical contact sensor comprises a stylus draggable along the print surface and a drag force sensor to detect the discontinuities by measuring changes in drag force on the stylus.
